(19) United States
(12) Patent Application Publication
(10) Pub. No.: US 2008/0280095 A1
(43) Pub. Date: Nov. 13, 2008

(54) SURFACE PROTECTION MAT

(76) Inventor: Rickie J. Wright, Canton, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/175,964

(22) Filed: Jul. 18, 2008

Related U.S. Application Data
(63) Continuation-in-part of application No. 11/451,706, filed on Jun. 13, 2006.

(51) Int. Cl. B32B 3/12

(52) U.S. Cl. 428/118

(57) ABSTRACT

A mat for protecting surfaces from the accumulation of liquids is provided. The mat comprises a molded polymeric grid layer made of an elastomeric material having several openings and an absorbent core. The absorbent core comprises a moisture absorbent layer and a moisture barrier layer. The grid layer has a surface engaging perimeter, and the moisture barrier comprises a skid resistant material. The mat is foldable from an unfolded configuration to a first folded configuration and from the first folded configuration to a second folded configuration.

### CROSS-REFERENCE TO RELATED APPLICATIONS

This application is a continuation-in-part of U.S. patent application Ser. No. 11/451,706 the entirety of which is hereby incorporated by reference.

### TECHNICAL FIELD

This disclosure relates to a surface protection mat for protecting surfaces exposed to liquids, including liquids dropped thereupon and walked upon by the public, such as at entrances to buildings, high traffic areas, cafeterias and like places. It also relates to the protection of surfaces that are stood upon by a person or which generally come into contact with a person's feet and which may accumulate liquids as a result of such contact.

### BACKGROUND

Floors and countertops are subject to accidental liquid spills, and in the case of floors, potentially causing slip and fall hazards. Also, the liquid from the spills often damages the surface causing costly repairs. To preserve a dry condition, these floors and countertops require constant maintenance.

Normally, scheduled maintenance is used to monitor and clean up accidental spills. These spills occur frequently and often go unnoticed for long periods of time. Currently, excessive maintenance schedules attempt to solve the problem. However, damage to the surface still occurs between maintenance.

If a floor is exposed to a liquid spill, a danger is presented that a user will slip and fall. This is an ongoing problem in bathrooms and near urinals on tile surfaces where urine may drip when a user misses the target. As such, floor mats are extremely desirable in restrooms both for protecting users from unexpected dangers and for protecting the restroom floors from urine drippings.

In addition, vehicle floors may be come wet if the vehicle occupants get liquids or snow on their shoes or spill liquids in the vehicle, thereby causing the carpet on the vehicle floor to degrade in texture and/or appearance. Many vehicles include mats intended to protect the vehicle carpet. However, many known mats cannot absorb liquids, suffer from poor disposability, and/or are ill-suited for being trod or stood upon by users. Thus, a need has arisen for a surface protection mat that addresses the foregoing issues.

### BRIEF DESCRIPTION OF THE DRAWINGS

FIG. 1 is a plan view looking down at the top surface of a moisture resistant sheet provided with a central honeycomb structure for funneling liquids therefrom, the sheet forming part of a surface protection mat according to the present invention;

FIG. 2 is a plan view of a multilayer cartridge unit adapted to be mounted in a cavity formed in the bottom side of the moisture resistant sheet of FIG. 1, the cartridge unit forming part of the surface protection mat according to the present invention;

FIG. 3 is a side elevation view, in section, taken along line 3 of FIG. 1, showing detail of a peripheral edge portion of the sheet and the cavity formed in the bottom side thereof;

FIG. 4 is a side elevation view, in section, taken along line 4 of FIG. 1, illustrating a lift tab provided in the peripheral edge of the sheet for use in lifting the surface protection mat from the floor;

FIG. 5 is a section view, taken along line 5 of FIG. 2, showing the multilayer cartridge unit and absorbent and moisture barrier layers thereof;

FIG. 6 is an enlarged plan view looking down at some of an array of hexagonal shaped drain funnels that extend downwardly between the top and bottom surfaces of the moisture resistant sheet of FIG. 1;

FIG. 7 is an enlarged elevation view, in section, taken along line 7-7 of FIG. 6, showing detail of a hexagonal drain funnel;

FIG. 8 is a side elevation view, in section, of cartridge unit assembled to the moisture resistant sheet to form a surface protection mat, showing the absorbent and moisture barrier layers mounted within the cavity;

FIG. 9 is a plan view, showing the bottom side of an alternate embodiment of a moisture resistant sheet according to this invention, wherein the outer periphery thereof is provided with a plurality of sections of flexible floor engaging skid resisting ribs;

FIG. 10 is an elevation view, taken along line 10 of FIG. 9, showing a section of flexible floor engaging skid-resisting ribs.

FIG. 11 is a top plan view of an embodiment of a surface protection mat mat;

FIG. 12 is a bottom plan view of an embodiment of a surface protection mat of FIG. 11;

FIG. 13 is a cross-sectional view of the grid layer of FIG. 11 taken along the line 13-13;

FIG. 14 is a cross-sectional, fragmented view of the surface protection mat of FIG. 11 with the mat oriented upside down;

FIG. 15 is a view of the bottom of the mat of FIG. 11 in a first folded configuration;

FIG. 16 is a view of the bottom of the mat of FIG. 12 in a second folded configuration;

FIG. 17 depicts the mat of FIG. 11 placed proximate a urinal;

FIG. 18 depicts a surface protection mat configured for placement proximate a commode;

FIG. 19 depicts a surface protection mat placed proximate a commode; and

FIG. 20 depicts the surface protection mat of FIG. 11 placed on a vehicle floor.

### DETAILED DESCRIPTION OF THE PREFERRED EMBODIMENT(S)

This disclosure relates to multi-layered surface mat protection mats that are disposable and which are configured to direct fluids through a polymeric top layer to an absorbent core with a barrier layer used to prevent liquids from leaking through the mat or otherwise contacting the surface due to saturation of the mat. Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

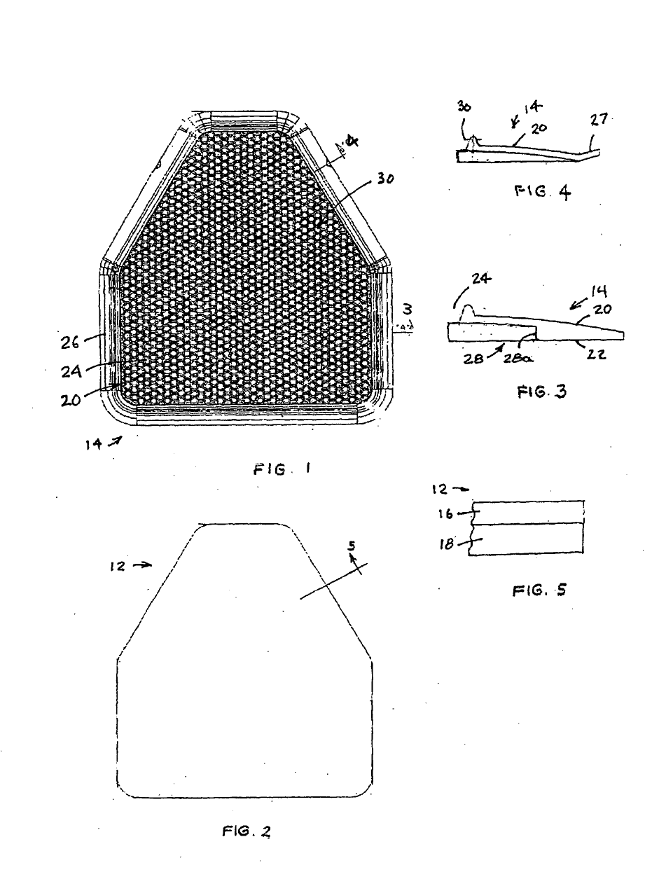

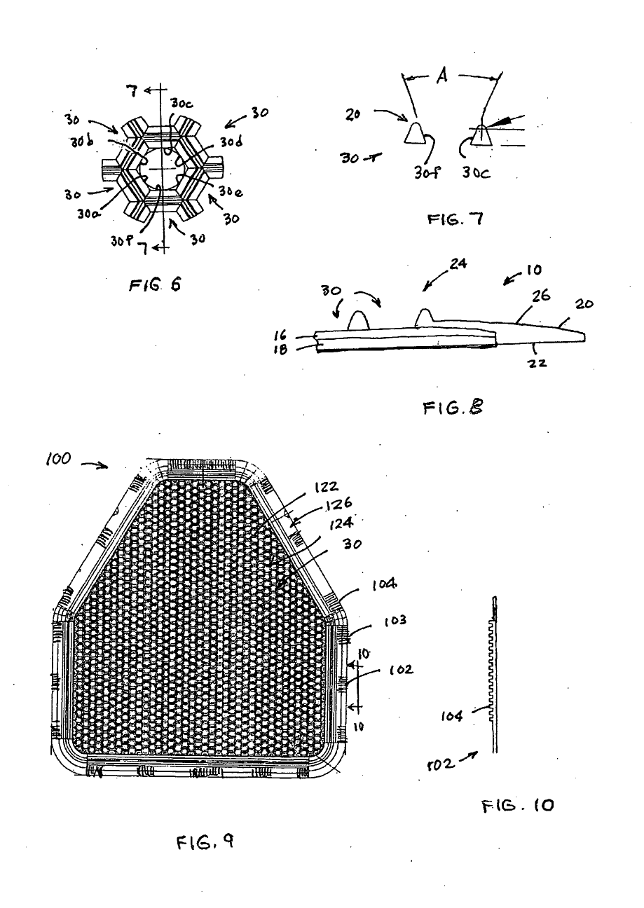

A first preferred embodiment is illustrated in FIGS. 1-8 and comprises a surface protection or liquid absorbing mat, generally indicated by the reference number 10, which is adapted to be placed as a protective covering upon a floor to capture fluids spilled thereon. Importantly, such protection mat prevents the floor from becoming stained or otherwise attacked by fluids, and also protects persons in the area from accidentally slipping and falling.

The surface protection mat 10 may be used in many places, such as entranceways, cafeterias, and other heavily used areas where persons pass, but which surface may be had liquids spilled thereon. Also, floor areas in front of vending machines could be subject to such problems.

In particular, the surface protection mat 10 is intended to be used in restrooms and the like and to be placed on the floor surface about a toilet, commode, or under a man's wall mounted urinal to capture the dripping of urine during a urinating activity. The protection mat 10 protects the floor from staining as well persons from slips and falls occasioned by walking on such floor surface. Additionally, the mat is of sufficient thickness to not only capture undesirable drippings but also provide a slip free surface that the user may stand upon and protect the feet from such fluids.

The liquid absorbing mat 10 for placement on a surface and protecting the surface from liquid spills includes a top layer 14 and an absorbent core that comprises a generally planar semi-rigid cartridge 12. The absorbent core 12 comprises, at least in part, an upper layer 16 of fluid absorbing material, and a lower layer 18 of fluid impervious material that resists passage of fluid and having a coefficient of friction that resists movement when placed on the floor or like receiving surface.

The top layer 14 is of semi-rigid material and includes a topside 20 adapted to be stood upon to protect the foot of a user, a bottom side 22 adhered, at least in part, to the upper layer 16 of fluid absorbing material and adapted to be placed on the floor or like receiving surface. Further, the top layer 14 includes a central portion 24 and a peripheral portion 26 that encircles the central portion.

To assist maneuvering and placement of the mat, a pair of lift tabs 27 are provide on the outer peripheral portion 26.

The bottom side 22 includes a shaped cavity 28 (FIG. 3) within which the absorbent core 12 is interfitted and superposed by the central portion 24. The shaped cavity 28 includes an outer peripheral wall 28a of predetermined height and is complementary to the shape and thickness of the absorbent core 12. A substantially continuous floor engaging surface is defined by the bottom side of the outer peripheral portion of the top layer 14 and the bottom side of the lower layer 18 when the absorbent core 12 is interfitted within the cavity 28. To resist skidding and movement, the bottom side of the moisture barrier 18 may be spaced from the bottom side of the top layer 14 whereby to engage the floor surface when the support mat 10 is placed thereupon.

Importantly, the central portion 24 is substantially completely defined by a honeycomb type structure formed of a plurality of contiguous like shaped hexagonal funnels 30, the funnels being symmetrically centered on respective geometric axes that are generally perpendicular to a plane including the top layer 14. The funnels 30 extend through the top layer 14 and direct liquid from the topside 20 downwardly and onto the upper layer 16 of fluid absorbing material.

Desirably, the honeycomb structure, and associated hexagonal shaped funnels, has unexpected advantages over other shapes. The hexagon fills the space with minimal perimeter per piece area. Thus a hexagonal structure uses the least material to create a lattice of cells with a given volume.

Each hexagonal shaped funnel 30 forms hexagonal shaped upper and lower end portions and is comprised of six sidewalls 30a, 30b, 30c, 30d, 30e, and 30f for directing fluid downwardly onto the upper layer 16 of fluid absorbing material. The sidewalls 30a-30f narrow and slope inwardly towards one another from the topside downwardly to the bottom side. The end portions of the hexagonal shaped funnels 30 are concentrically disposed on the geometric axis of the funnel with the lower end portion forming a discharge opening that is smaller than the entry into the throat formed at the upper end portion.

Each hexagonal shaped funnel 30 defines three pairs of opposed inwardly angled sidewalls, such as 30a and 30d, 30b and 30e, and 30c and 30f, each pair of opposed sidewalls being symmetrically disposed at a double included angle “A” of about 37° to 42° relative to the center geometrical axis of the funnel. Stated differently, each sidewall of a hexagonal fluid passing funnel 30 of the honeycomb structure is at an angle of about 18° to 21° relative to the geometric axis of the hexagonal shape. Preferably the double included angle is about 40°.

The wall defining the narrowing sidewalls is substantially V-shaped in cross-section, defines a sidewall in each of two adjacent contiguous funnels 30, and the sidewalls of each V-shaped wall are at the above noted double included angle.

Further, each V-shaped wall terminates in a rounded apex to receive and direct fluid into the downwardly narrowing funnel.

In one aspect, the vertical distance between the topside 20 and the bottom side 22 define a predetermined thickness of the support mat 10, and the funnel 30 forms a throat of hexagonal cross-section that narrows from the entry at the topside to the outlet discharge proximate to the top surface of the upper layer 16 of absorbent layer. The lateral dimension at the outlet discharge opening is substantially the same as the vertical thickness of the support mat 10.

Turning to FIGS. 9 and 10, an alternate embodiment of a support mat, is generally indicated by the number 100. In this support mat 100, everything is the same as described above with respect to the support mat 10, including a central section 124 having a honeycomb structure, except that the bottom side 122 of the outer peripheral portion 126 is provided with structure for resisting relative movement of the support mat 100 relative to the floor surface when the support mat 100 is placed thereon, the resisting structure being separate and apart from the lower layer 18 of the absorbent core 12 into the cavity 128 in the bottom side 122 (not shown in this view).

In particular, the structure for resisting movement of the support mat 100 relative to the floor comprises at least one section 102 of elongated flexible ribs 106, although a plurality of sections 102, 103, 104, etc are preferably disposed around the central portion 124. Shown best in FIG. 1, the ribs 106 are elongated, in side-by-side relation, and operate to engage the floor and flex slightly to resist lateral movement when a lateral force is placed on the support mat 100.

In each of the embodiments of liquid absorbing or surface protection mats 10 and 100 described hereinabove, the top layer 14 is comprised of a moisture impervious material selected from the group consisting of polypropylene, nylon, plastic, rubber, synthetic material, and cellulosic paper.

The upper layer 16 of the absorbent core 12 is comprised of a moisture absorbent material selected from the group consisting of (a) polymer and cotton-fluff, (b) fiber and cotton-fluff, each of (a) and (b) having ten percent cotton-fluff, and (c) wood pulp.

The moisture barrier 18 forms a seal to prevent leakage of the liquid and has a coefficient of friction that resists movement when placed atop a surface. Preferably, the moisture barrier 18 is herein is comprised of a TPE compound, consisting of a styrenic block copolymer (such as SBS, SEBS, SEPS), a hydrocarbon oil, a polyolefin polymer (such as PPH, PPC, PE), fillers (such as CaCO₃, talc, etc.), a heat stabilizer, a color additive, and other additives (such as for odor control).

The absorbent core 12 is formed as an interfittable unit in that the upper surface of the moisture barrier 18 is secured to the lower surface of the upper layer 16. Further, for final assembly of the sealed disposable product, the upper surface of the upper layer 16 is adhesively secured to the bottom side (as defined in the cavity 28) by a suitable adhesive, and the outer periphery of the absorbent core 12 is secured to the cavity wall 28a by a suitable adhesive. In some applications the upper and lower layers 16 and 18 may be sonic-welded.

In general, the resulting urinal mat has an advantage over prior art designs in that the mat is soft and flexible. Additionally, the material makes for a urinal mat that is somewhat heavy. These features ensure that the mat will stay flat to the floor. Further, the urinal mat is easier to dispose of, when the useful life is over, in that the mat will bend in half.

Importantly, the top layer 14 provides an array of hexagonal shaped openings, which openings are somewhat more open than the square-shaped openings of the prior art and provide a more effective funneling action. Another advantage of this honeycomb structure in the top layer is that the absorbent core 16 therebelow is more visible to the end-user. When the absorbent core is soiled from use, such fact will be more apparent to the end-user. As a result the user will tend to replace the mat more often, leading to a cleaner more sanitary facility.

Further, the top grid layer 14 is comprised of a material (e.g., polypropylene) that is soft and more flexible (not as rigid), which feature will allow the mat to conform to the shape of the floor surface and lay flat, thereby helping to eliminate possible trip hazards. Additionally, provision of a softer more flexible material makes the urinal mat more difficult to kick out of place. Flexibility and softness of the respective mat layers makes the urinal mat more likely to bend rather than slide across the floor. Furthermore, because of the overall flexibility of the mat, it is easier to dispose of since it can easily be folded or rolled up and placed in a suitable trash receptacle.

While there many methods available, a “softer” polypropylene is made by using a gas-assisted process in the injection molding procedure.

Additionally, the top grid layer 14 has a finished tapered edge to keep it very low and flat to the floor surface. Advantageously, such feature will minimize the likelihood of slip-and-falls as well as allow for custom labeling, if desired by an end-user or customer.

The moisture barrier or bottom layer 18 serves as a moisture barrier to prevent fluids from reaching the floor surface. Importantly, the material of the moisture barrier 18 is non-slip and non-skid (i.e., has a high coefficient of friction), and does not rely on adhesive, which would leave residue on the floor. This material makes the bottom layer 18, and thus the product, much safer in that the material continually hold the urinal mat in correct position under the urinal and commode to catch urine dropping.

Accordingly, while the main focus of the mat 10 and 100 herein has been described in connection with floor protection, the invention addresses countertop and other surfaces as well.

Further, the shape of the mat may be other than that shown, depending on the use and desired application. For example, the mat can be circular, oval, trapezoidal, triangular, etc. The mat can comprise a urinal mat, a commode or the like.

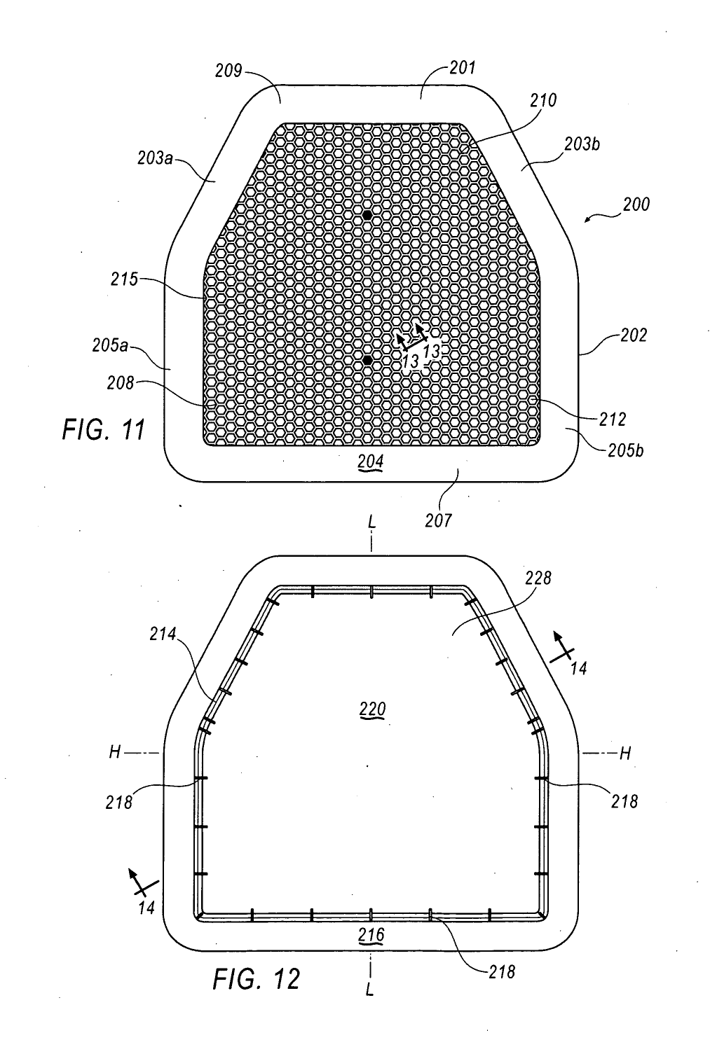

Referring to FIGS. 11-16, another embodiment of a surface protection mat 200 is depicted. Surface protection mat 200 is preferably flexible and may have a variety of shapes. However, in the embodiment of FIGS. 11-16, the shape of mat 200 is defined by front border 201, rear border 204 and a plurality of sides 203a, 203b, 205a, and 205b. Front border 201 is spaced apart from and substantially parallel to rear border 204. Rear sides 205a and 205b are substantially parallel to and spaced apart from one another and are connected to opposite ends of rear border 204. Front sides 203a and 203b are each connected at one of their respective ends to a corresponding end of front border 201 and at the other of their respective ends to the corresponding rear side 205a or 205b. As indicated in FIG. 11, in an exemplary embodiment, front border 201 is shorter in length than rear border 207. In addition, front side 203a defines an angle with respect to rear side 205a that is substantially equal to an angle defined between front side 203b and rear side 205b. A user may stand on surface protection mat 200 when it is in use. However, in a preferred method of use, the user straddles the mat with his feet placed on either side of it proximate angled front sides 203a and 203b. The use of such angled sides allows the user to stand over mat 200 without having to stand on it.

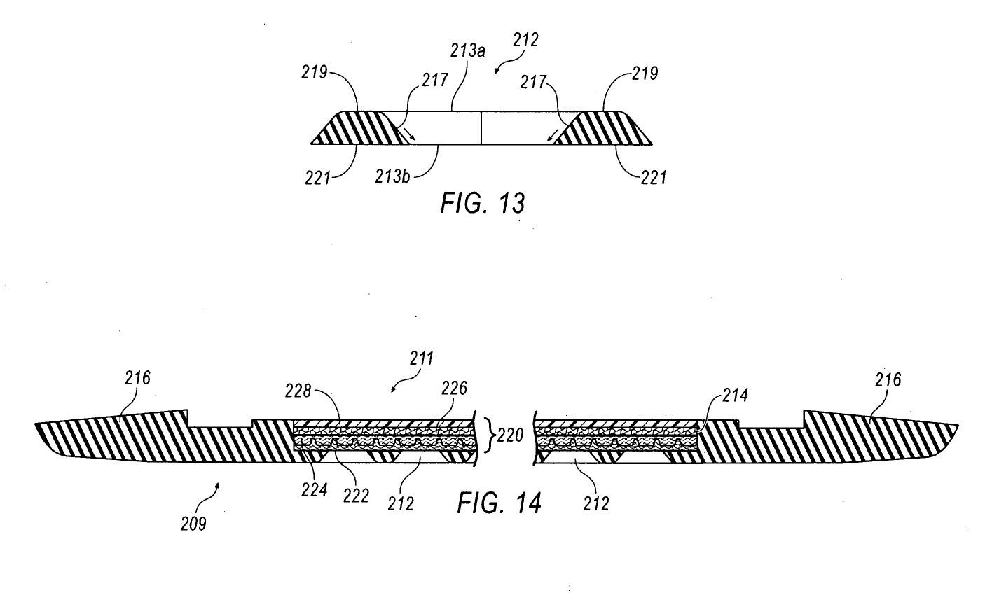

Surface protection mat 200 includes top surface 209, bottom surface 211, and comprises a molded polymeric grid layer 202 and an absorbent core 220. Absorbent core 220 (see FIG. 14) includes moisture absorbent layer 224, and a moisture barrier layer 228. Absorbent core may also include a liquid pervious layer 222. Mat 200 also preferably includes a deformable support layer 226. In the embodiment of FIGS. 11-16, the liquid pervious layer 222 is porous and is disposed between the molded polymeric grid layer 202 and moisture absorbent layer 224. The support layer 226 is located between the moisture barrier layer 228 and the moisture absorbent layer 222.

Molded polymeric grid layer 202 preferably includes a grid 210 comprising a plurality of openings 212 as well as a perimeter region 204. The bottom side 216 of perimeter region 204 (i.e., the side facing away from the user) is shown in FIG. 12. When placed on a surface, bottom side 216 of perimeter region 204 preferably engages the surface and acts to resist movement or skidding of mat 200 which would tend to result from the movement of a user's feet. Bottom surface 216 of perimeter region 204 preferably resists skidding on surfaces such as wood, tile, concrete, etc.

Perimeter region bottom surface 216 of molded polymeric grid layer 202 preferably conforms to non-flat surfaces with undulations or other surface imperfections to aid in resisting skidding or movement. In one embodiment, molded polymeric grid layer 202 is elastomeric. In a preferred implementation, grid layer 202 is a thermoplastic olefinic (“TPO”) material that is elastomeric.

Molded polymeric grid layer 202 comprises a material that has a shore A hardness as measured by ASTM-D2240 which provides flexibility and skid resistance and which is generally less than about 50. In urinal and commode mat applications, the material comprising grid layer 202 has a shore A hardness ranging preferably from about 10 to about 30, more preferably from about 15 to about 25, and most preferably from about 15 to about 20.

In urinal and commode mat applications, the material comprising molded polymeric grid layer 202 also has a tensile strength as measured by ASTM D-412 that ranges generally from about 300 psi to about 500 psi, preferably from about 350 psi to about 450 psi, and more preferably from about 380 psi to 420 psi. The molded polymeric grid layer 202 material further has an ultimate elongation as measured by ASTM D-412 that ranges generally from about 600% to about 1200%, preferably from about 700% to about 1000%, and more preferably from about 800% to about 900%. In addition, the molded polymeric grid layer 202 material has a tensile modulus as measured by ASTM D-412 which ranges generally from about 60 psi to about 200 psi, preferably from about 90 psi to about 150 psi, and more preferably from about 110 psi to about 130 psi.

In one example, polymeric grid layer 202 is molded (e.g., injection molded or compression molded) from a thermoplastic olefinic material supplied by the Teknor Apex Company of Pawtucket, R.I. under the trade name TELCAR® TL-1122A. TELCAR® TL-1122A has an ASTM D-2240 shore A hardness that is typically about 17, an ASTM D-412 tensile strength that is typically about 400 psi, an ASTM D-412 ultimate elongation that is typically about 850% and an ASTM D-412 tensile modulus that is typically about 120 psi. TELCAR® TL-1122A also has an ASTM D-792 specific gravity that is typically about 1.05 and an ASTM D-1238 melt index condition E (190° C./2.16 kg) that is typically about 5.0 g/10 minutes.

As shown in FIG. 11, grid region 210 defines a plurality of openings 212 through which a liquid may pass to absorbent core 220. Openings 212 have a thickness that is the same as the thickness of grid region 210. Openings 212 may be circular, oval, elliptical, or polyogonal in cross-section. In the embodiment of FIG. 11, the polymeric material comprising grid layer 202 defines a plurality of polygons 208 with corresponding polygonal openings 212. Each opening is preferably defined within six (6) walls that form three (3) pairs of walls with the members of each pair being in facing opposition to one another as illustrated in the embodiment of FIG. 6. The polygons are hexagons and polygonal openings 212 are hexagonally-shaped. Along the outer periphery of grid region 210, partial hexagonal openings 215 are provided.

Molded polymeric grid layer 202 is configured to direct liquids to absorbent core 220. In certain illustrative examples, openings 212 provide a funneling effect achieved by narrowing the openings through the thickness of grid region 210 of grid layer 202. One illustrative example of a structure that provides such as funneling effect is shown in FIG. 13. FIG. 13 depicts a cross-sectional view of a portion of grid region 210 of mat 200. In certain preferred implementations, as shown in FIG. 13, the polygons defining openings 212 include sidewalls 217 that slope inwardly toward the center of each opening 212 (linearly or non-linearly) from the top surface 219 to the bottom surface 221 of grid region 210 of grid layer 202. The inwardly sloping sidewalls 217 aid in directing liquid contacting mat 200 from molded polymeric grid layer 202 to absorbent core 220. Because of the sloping of sidewalls 217, the open area 213a defined at the top of each of the openings 212 (i.e., at the top surface 219 of grid region 210) is greater than the open area 213b at the bottom of each of the openings 212 (i.e., at the bottom surface 221 of grid region 210). Thus, liquid is directed in the direction of the arrows shown in FIG. 13.

Mat 200 is preferably configured to allow the skid resistant material comprising molded polymeric grid layer 202 to contact the surface on which mat 200 is placed. In one embodiment, this configuration is facilitated by providing a recess defined in the polymeric grid layer 202 in which the absorbent core 220 is disposed. Referring to FIGS. 12 and 14, a recessed region or compartment 214 is defined within molded polymeric grid layer 202 and is bounded by the peripheral region bottom surface 216. Recessed region 214 is preferably sized to accommodate absorbent core 220 which is disposed therein. FIG. 14 depicts mat 200 placed upside down (i.e, with bottom surface 211 facing upward) to illustrate the structure of the recess and the manner in which absorbent core 220 is disposed in it. As FIG. 14 indicates, when mat 200 is placed on a surface such that top mat surface 209 is contacting the surface (i.e, upside down), absorbent core 220 is preferably recessed such that it remains below the plane of bottom surface 216 of molded polymeric grid layer perimeter region 204 (see FIG. 14). However, in a preferred embodiment, grid region 210 has sufficient weight that when bottom mat surface 211 is placed on a surface without any external force applied to it (e.g., in normal use but without a user standing on it), both bottom surface perimeter region 216 and moisture barrier layer 228 engage the surface, thereby providing additional skid resistance beyond that provided by bottom surface 216 of molded polymeric grid layer perimeter region 204 alone.

Absorbent core 220 may be secured to molded polymeric grid layer 202 in a number ways, including with an adhesive or sonic welding. However, in the embodiment of FIGS. 12 and 14, molded polymeric grid layer 202 is molded over the absorbent core 220 so that as the material comprising molded polymeric grid layer 202 cools and solidifies following molding, it adheres to absorbent core 220, thereby securing it in place within recessed region 214. As shown in FIG. 12, a plurality of retention ribs 218 may also be provided to aid in holding absorbent core 220 in place and may also aid in providing additional skid resistance. Thus, absorbent core 220 and molded polymeric grid layer 202 preferably define a single piece, unitary mat 200.

Referring to FIG. 14, an illustrative example of absorbent core 220 is depicted. Absorbent core 220 preferably has a saturation capacity that provides the desired duration of use at the anticipated liquid exposure. In certain illustrative examples, the saturation capacity ranges generally from about 10 g liquid/g absorbent core to about 30 g liquid/g absorbent core, preferably from about 15 g liquid/g absorbent core to about 25 g liquid/g absorbent core, and more preferably about 20 g liquid/g absorbent core. Absorbent core 220 preferably has a density ranging generally from about 0.01 g/cm³ to about 0.2 g/cm³, preferably from about 0.05 g/cm³ to about 0.15 g/cm³, and more preferably from about 0.06 g/cm³ to about 0.08 g/cm³.

In certain illustrative examples, absorbent core 220 has a weight per unit area ranging generally from about 100 g/m² to about 300 g/m², preferably from about 150 g/m² to about 250 g/m², and more preferably from about 180 g/m² to about 220 g/m².

Referring again to FIG. 14 (in which mat 200 is depicted upside down), absorbent core 220 comprises a liquid pervious layer 222, a moisture absorbent layer 224, a deformable support layer 226, and a moisture barrier layer 228. Moisture absorbent layer 224 preferably comprises a light weight material capable of absorbing liquid. In one embodiment, moisture absorbent layer 224 comprises a wood pulp material combined with a super absorbent material, such a super absorbent fiber or a super absorbent powder. The wood pulp comprising moisture absorbent layer 224 comprises generally from about 25% to about 50% by weight, preferably from about 30% to about 40% by weight, and more preferably from about 30% to about 35% by weight of moisture absorbent layer 224.

Liquid pervious layer 222 preferably comprises a web-like, non-woven fiber sheet and allows liquid to pass from grid layer openings 212 to moisture absorbent layer 224 such that moisture absorbent layer 224 is in fluid communication with openings 212. In certain applications, the accumulation of absorbed liquid in moisture absorbent layer 224 can result in the formation of a gel which may ooze through grid openings 212 causing a slipping hazard and a potentially unpleasant appearance. Liquid pervious layer 222 aids in restraining the expansion and swelling of moisture absorbent layer 224 so that any such gel will be less likely to protrude through openings 212.

Support layer 226 is preferably a thin deformable layer. In one preferred implementation, support 226 comprises a deformable paper product such as cardboard or chipboard. The use of support layer 226 provides mat 220 with structural integrity while still allowing it to conform to surfaces to which it is applied. Support layer 226 is preferably deformable yet strong enough to withstand tearing during normal use and aids in providing a foldable mat.

Moisture barrier layer 228 is preferably a thin moisture impervious film. The film is preferably skid resistant when placed on surfaces such as tile, wood, concrete, etc. and also resistant to tearing under normal use. Suitable films include films comprising ethylene-vinyl acetate copolymers such as EVATANE® high content EVA copolymers supplied by Arkema of France. Exemplary grades of EVATANE® include 18-150, 18-500, 20-20, 24-03, 28-03, 28-05, 28-25, 28-40, 28-150, 28-420, 28-800, 33-25, 33-45, 33-400, and 40-55.

The components of absorbent core 220 may be individually secured to one another. In addition, moisture barrier layer 228 and liquid pervious layer 222 may be sized and secured to one another to sandwich moisture absorbent layer 224 and support layer 226 between moisture barrier layer 228 and liquid pervious layer 222. Any or all of the components of absorbent core 220 may be adhered to one another by an adhesive, by mechanical means, or by a polymeric coating that solidifies to hold the components together. In one embodiment, a polymeric coating is disposed between moisture barrier layer 228 and support layer 226 and between support layer 226 and moisture absorbent layer 224. In an illustrative example, the polymeric coating comprises a polypropylene homopolymer such as Marlex® SMX-360. The polymeric coating may be applied at discrete locations across support layer 226 or as a continuous film, but a continuous film is preferred.

Liquid pervious layer 222 and moisture absorbent layer 224 may be supplied separately or as an integrally formed composite material such as NOVATHIN® SAP, Airlaid Composite CENT NWT, which is supplied by EAM Corporation of Jessup, Ga.

In one illustrative example, mat 200 is configured to prevent tripping when placed on a floor surface. In accordance with this embodiment, the peripheral region 204 of molded polymeric grid layer 202 is beveled so that its thickness is reduced toward the outer edges of mat 200. In addition, mat 200 may be provided with a low profile to further minimize tripping hazards. In one example, mat 200 has a profile (i.e., an overall thickness) that is generally no greater than 0.3 inches, preferably no greater than 0.25 inches, and more preferably no greater than 0.20 inches.

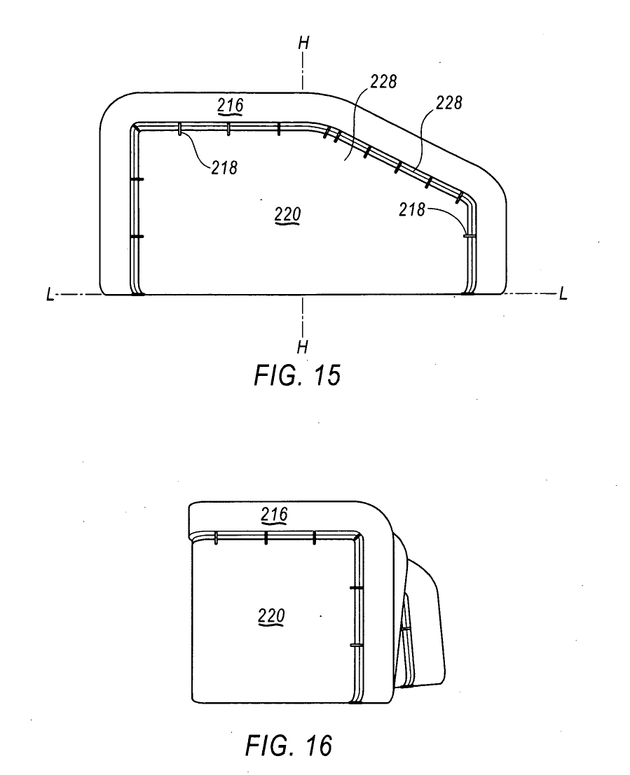

In one preferred embodiment, mat 200 is disposable. In a preferred implementation, mat 200 may be folded into a stable folded configuration having a reduced surface area for ease of disposal. Referring to FIGS. 11 and 12, mat 200 is shown in an unfolded condition. Following a period of use, mat 200 may be folded from the unfolded condition to a first folded condition as shown in FIG. 15. In the illustrative example of FIG. 15, mat 200 is symmetrically folded about its longitudinal axis, L. However, mat 200 may be folded in a number of different configurations, and the one shown in FIG. 15 is merely exemplary. In the illustrative example of FIG. 16, mat 200 is folded from the first folded configuration of FIG. 15 to the second folded configuration of FIG. 16. In the second folded configuration depicted in FIG. 16, mat 200 is folded about a horizontal axis, H, defined between the intersection of sides 203a and 205a and the intersection of sides 203b and 205b. However, this configuration is merely exemplary, and a variety of different second folded configurations may be used. It is preferred that the folded configurations of FIGS. 15 and 16 are stable, i.e., that once folded mat 200 remains in the folded configuration until further manipulated by a user.

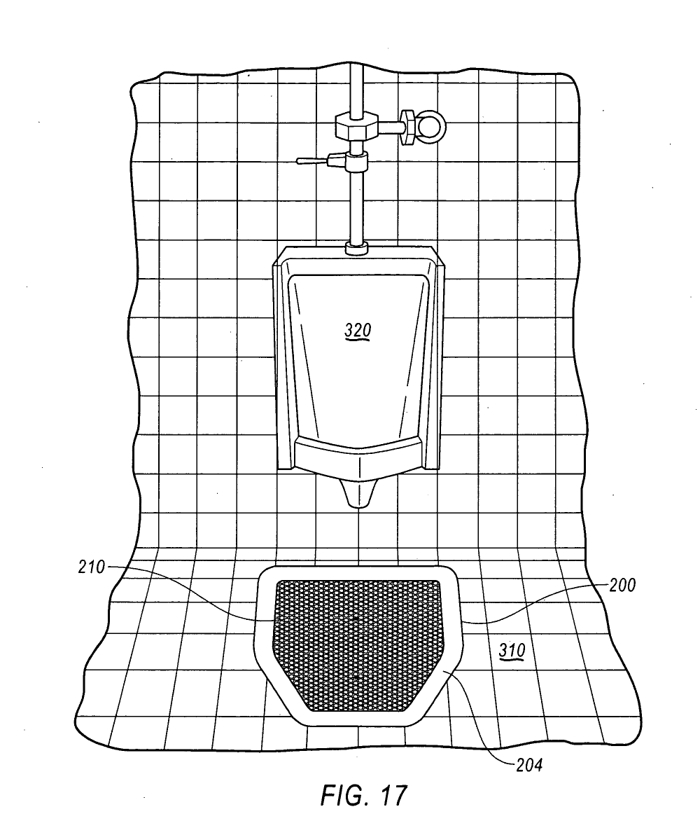

The surface protection mat of FIGS. 11-16 has a variety of different uses. In accordance with one method depicted in FIG. 17, mat 200 is placed on a restroom floor 310 proximate a urinal 320 to collect urine, water, or other liquids from the user or the urinal. Although a user could stand on mat 200, the user preferably straddles mat 200 with his feet placed proximate front sides 203a and 203b such that he is standing over at least a portion of mat 200. Liquids falling onto mat 200 preferably flow through openings 212 and into absorbent core 220. If liquid pervious layer 222 is provided in absorbent core 220, liquid flows through it to moisture absorbent layer 224 where it is absorbed. The flow of liquids from absorbent core 220 to the floor 310 is substantially prevented by moisture barrier layer 228. Mat 200 is preferably removed once it becomes saturated with liquid or prior to reaching saturation to prevent liquid from being squeezed out of moisture absorbent layer 224 when a user steps on mat 200. In one preferred embodiment, mat 200 is folded from the unfolded configuration of FIGS. 11 and 12 to the first folded configuration of FIG. 15 and then discarded in a refuse bin. In another embodiment, mat 200 is folded from the first folded configuration of FIG. 15 to the second folded configuration of FIG. 16 before being discarded in a refuse bin.

In accordance with a preferred embodiment of the foregoing method, when surface protection system mat 200 is placed on a surface such as a floor, peripheral region bottom surface 216 and at least a portion of moisture barrier layer 228 contact the floor regardless of whether an external force (such as the weight of a user) is applied to molded polymeric grid layer. Despite the inclusion and configuration of recessed region 214 on the bottom of surface protection system mat 200, the weight of grid region 210 is preferably sufficient to cause at least a portion of moisture barrier layer 228 to contact the surface. As a result, moisture barrier layer 228 aids peripheral region bottom surface 216 in resisting skidding.

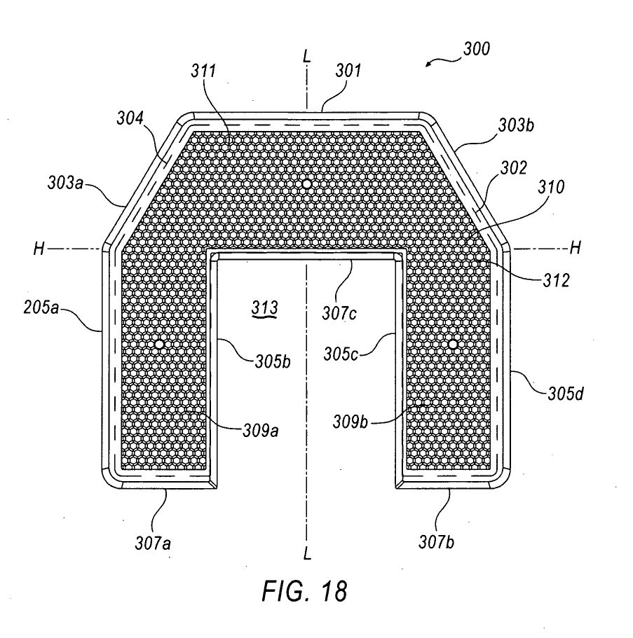

Referring to FIG. 18, an embodiment of a surface protection system mat 300 that is especially well-suited for use in preventing the accumulation of liquids proximate a commode is shown. Commode surface protection mat 300 is generally U-shaped and comprises a main body 311 from which two spaced apart legs 309a and 309b depend. First leg 309a is defined by first rear border 307a, first rear lateral side 305a, and first rear medial side 305b. First rear lateral side 305a and first rear medial side 305b are spaced apart from and substantially parallel to one another. Second leg 309b is defined by second rear lateral side 305d, second rear medial side 305c and second rear border 307b. Second rear lateral side 305d and second rear medial side 305c are spaced apart from and substantially parallel to one another. Third rear border 307c is spaced apart from first and second rear borders 307a and 307b in a direction parallel to the lengthwise direction of legs 309a and 309b. The total rear border length defined by first rear border 307a, second rear border 307b, and third rear border 307c is greater than the length defined by front border 301.

Open area 313 is defined between first leg 309a and second leg 309b. Main body 311 is defined by front border 301, third rear border 307c, first front side 303a and second front side 303b. Open area 313 is preferably rectangular or square and has a width defined by the length of third border 307c and a length defined by the length of first rear medial side 305b and second rear medial side 305c.

Other than its overall shape, commode surface protection mat 300 is substantially similar in construction to surface protection mat 200 discussed previously. Surface protection mat 300 includes a molded polymeric grid layer 302 comprising a grid 310 and a perimeter 307. Perimeter 304 runs along front border 301, first front side 303a, first rear lateral side 305a, first rear border 307a, first rear medial side 305b, third rear border 307c, second rear medial side 305c, second rear border 307b, second rear lateral side 305d, and second front side 303b. Surface protection system mat 300 includes an absorbent core 320 (not shown) that is also disposed within a recess on the underside of grid layer 202 of mat 300 in the same manner as shown in FIGS. 11-16 for absorbent core 220 and mat 200. Absorbent core 320 (not shown) is constructed of the same materials described previously for absorbent core 220. Grid 310 includes a plurality of openings 312 which allow liquid to pass from grid layer 302 to absorbent core 320 in the same manner as described for mat 200. Grid 310 is preferably elastomeric and in certain exemplary implementations is an elastomeric thermoplastic olefin of the types described for molded polymeric grid layer 202.

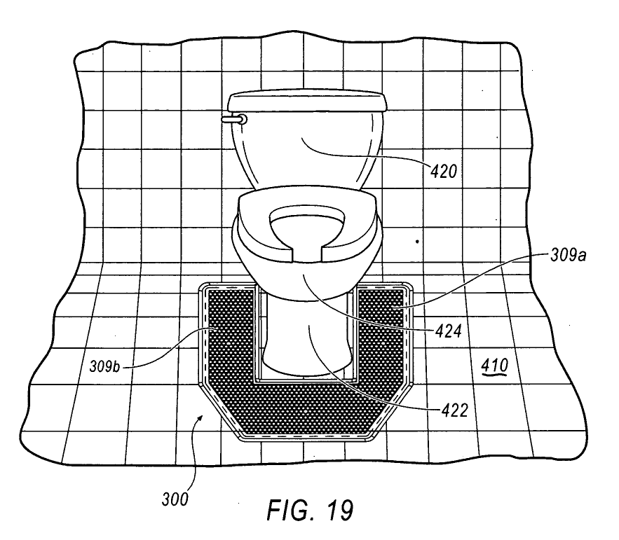

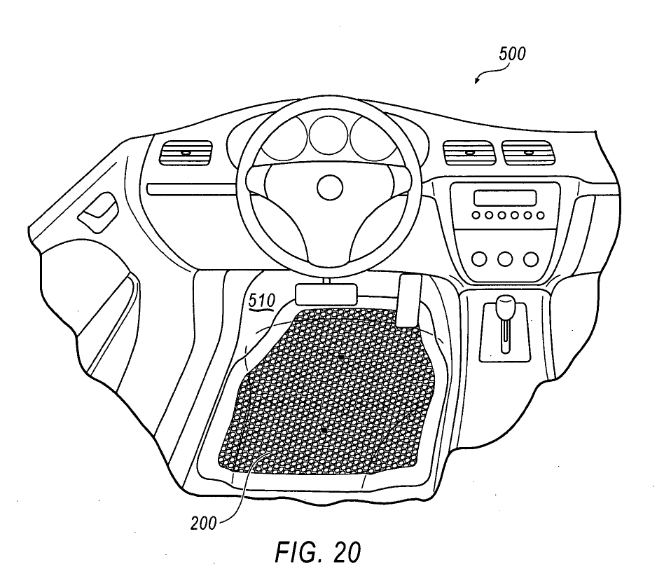

Referring to FIG. 19, a method of using surface protection mat 300 to prevent the accumulation of liquids proximate a commode 420 is provided. In accordance with the method, surface protection system mat 300 is placed on floor 410 proximate commode 420 so that the base 422 of the commode (on which the bowl 424 sits) is at least partially enclosed by mat 300. Mat 300 is preferably positioned so that at least a portion of the commode base 422 is disposed within open area 313. Liquids collected from the commode or user are directed through openings 312 to absorbent core 320 (not shown). At a selected time, mat 300 is removed from proximate the commode and discarded. In one embodiment, mat 300 is folded from the unfolded configuration of FIG. 18 to a folded configuration in which it is folded about its longitudinal axis L. The folded mat is then discarded. In another embodiment, mat 300 is folded from a first folded configuration to a second folded configuration (e.g., by folding mat 300 about a horizontal axis H that is substantially perpendicular to the longitudinal axis L of mat 300) and discarded.

In accordance with another method of use, surface protection system mat 200 may be used to prevent the accumulation of liquids on the floor 520 of a vehicle 500 such as a car, truck, SUV, etc. An embodiment of such a method is depicted in FIG. 20. The vehicle floor 520 may be constructed of a rigid material such as a metal and may be carpeted. In accordance with the embodiment, surface protection system mat 200 of the construction described previously is provided and is placed on the vehicle floor 520 of vehicle 500 so that peripheral region bottom surface 216 of molded polymeric grid layer 202 contacts the floor 520. Many vehicle floors such as floor 520 have uneven contours. However, mat 200 is preferably constructed to substantially conform to such uneven contours using the materials of construction described previously. The passenger or driver proximate mat 200 preferably places his or her feet on grid region 210 such that any accumulated liquids (e.g., spilled liquids, rain, or melting snow) will be flow through openings 212 to absorbent core 220. After a selected period of use, mat 200 may be discarded. In one exemplary method, mat 200 is folded from an unfolded condition as shown in FIG. 11 into the first folded configuration of FIG. 15 and then put in a refuse bin. In another exemplary method, mat 200 is folded from the first folded configuration of FIG. 15 to the second folded configuration of FIG. 16 before being discarded. Thus, surface protection system mat 200 provide a convenient and disposable means of effectively protecting vehicle floors from the accumulation of spilled liquids or other liquids that accumulate on the shoes of a passenger or driver.

### EXAMPLE

Referring to FIGS. 11-16, an example of a method of making mat 200 will now be described. An injection molding machine is fitted with two injection mold halves that cooperatively fit together to form an internal cavity that defines the shape and structure of molded polymeric grid layer 202. An absorbent core 220 is provided which comprises a layer of NOVATHIN® SAP Airlaid Composite. The NOVATHIN® Composite is further comprised of both a moisture permeable layer 222 and a moisture absorbent layer 224. A chipboard layer of 0.030 inches thick supplied by Innovative Packaging LLC is provided as deformable support layer 226. The Airlaid composite is bonded to the chipboard using Marlex® SMX-360, a polypropylene homopolymer which is applied as a continuous film to the chipboard. A sheet of EVATANE® EVA copolymer is supplied and is bonded to the chipboard with the SMX-360 material, which is applied to the other side of the chipboard (i.e., the side of the chipboard opposite the Airlaid composite) as a continuous film. Thus, assembled, the absorbent core defined by the Airlaid composite, the chipboard, and the EVATANE® layer is inserted between the injection mold halves, and a TELCAR® TL-1122A TPO elastomeric material is heated and injected into the mold halves, resulting in the formation of molded polymeric grid layer 202 and resulting in the adherence of absorbent core 220 to it. Mat 200 is then removed from the injection mold and allowed to cool. Mat 200 has a total thickness of about 0.18 inches, is flexible, foldable, skid resistant and conforms to surfaces that are have surface contour variations.

It will be further appreciated that functions or structures of a plurality of components or steps may be combined into a single component or step, or the functions or structures of one-step or component may be split among plural steps or components. The present disclosure contemplates all of these combinations. Unless stated otherwise, dimensions and geometries of the various structures depicted herein are not intended to be restrictive of the disclosure, and other dimensions or geometries are possible. Plural structural components or steps can be provided by a single integrated structure or step. Alternatively, a single integrated structure or step might be divided into separate plural components or steps. In addition, while a feature of the present disclosure may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present disclosure.

The explanations and illustrations presented herein are intended to acquaint others skilled in the art with the disclosure, its principles, and its practical application. Those skilled in the art may adapt and apply the disclosure in its numerous forms, as may be best suited to the requirements of a particular use. Accordingly, the specific embodiments of the present disclosure as set forth are not intended as being exhaustive or limiting. The scope of the disclosure should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A surface protection mat, comprising:
an elastomeric grid layer having a plurality of openings and a surface engaging perimeter; and
an absorbent core layer mated to the elastomeric grid, wherein the absorbent core comprises a moisture absorbing layer in fluid communication with the openings and a moisture barrier layer.

2. The surface protection mat of claim 1, wherein the openings are hexagonal shaped.

3. The surface protection mat of claim 1, wherein the mat is flexible.

4. The surface protection mat of claim 1, wherein the mat has an unfolded configuration and a first folded configuration, and the mat is foldable from the unfolded configuration into the first folded configuration.

5. The surface protection mat of claim 4, wherein the mat has a second folded configuration, and the mat is foldable from the first folded configuration to the second folded configuration.

6. The surface protection mat of claim 1, wherein the moisture barrier comprises a skid resistant material.

7. The surface protection mat of claim 6, wherein the moisture barrier layer comprises an ethylene vinyl acetate copolymer.

8. The surface protection mat of claim 1, wherein the elastomeric grid layer comprises a thermoplastic olefin.

9. The surface protection mat of claim 1, wherein the elastomeric grid layer has a shore A hardness of less than about 50.

10. The surface protection mat of claim 1, wherein the elastomeric grid layer has a shore A hardness of from about 10 to about 30.

11. The surface protection mat of claim 1, wherein the elastomeric grid layer has a shore A hardness of from about 15 to about 25.

12. The surface protection mat of claim 1, wherein the absorbent core is adhered to the elastomeric grid layer by overmolding.

13. The surface protection mat of claim 1, wherein the elastomeric grid layer defines a recess bounded by the surface engaging perimeter, and the absorbent core is disposed in the recess.

14. The surface protection mat of claim 1, wherein the absorbent core further comprises a deformable support layer between the moisture absorbent layer and the moisture barrier layer.

15. A method of preventing the accumulation of liquid on a restroom floor comprising placing the mat of claim 1 on the restroom floor proximate one selected from a commode and a urinal.

16. The method of claim 15, wherein the step of placing the mat on the restroom floor comprises placing the mat on the restroom floor such that the surface engaging perimeter of the elastomeric grid layer contacts the floor and the moisture barrier layer contacts the floor when no external force is applied to the mat.

17. A method of preventing the accumulation of liquid on the floor of a vehicle, comprising placing the mat of claim 1 on the floor of the vehicle.

18. The method of claim 17, wherein the step of placing the mat on the vehicle floor comprises placing the mat on the vehicle floor such that the perimeter of the elastomeric grid layer contacts the floor and the moisture barrier layer contacts the floor when no external force is applied to the mat.

19. A surface protection mat, comprising:
a molded polymeric grid layer having a plurality of openings; and
an absorbent core,
wherein the absorbent core comprises a moisture absorbent layer in fluid communication with the openings, and a moisture barrier layer, and the mat has an unfolded configuration and a first folded configuration, and the mat is foldable from the unfolded configuration to the first folded configuration.

20. The surface protection mat of claim 19, wherein the moisture barrier layer comprises a skid resistant material.

21. The surface protection mat of claim 19, wherein the moisture barrier layer comprises an ethylene vinyl acetate copolymer.

22. The surface protection mat of claim 19, wherein the molded polymeric grid layer is elastomeric.

23. The surface protection mat of claim 19, wherein the mat is flexible.

24. The surface protection mat of claim 19, wherein the molded polymeric grid layer comprises a thermoplastic olefin.

25. The surface protection mat of claim 19, wherein the molded polymeric grid layer has a shore A hardness of less than about 50.

26. The surface protection mat of claim 19, wherein the molded polymeric grid layer has a shore A hardness of from about 10 to about 30.

27. The surface protection mat of claim 19, wherein the molded polymeric grid layer has a surface engaging perimeter.

28. The surface protection mat of claim 27, wherein the molded polymeric grid has a recess bounded by the surface engaging perimeter, and the absorbent core is disposed in the recess.

29. The surface protection mat of claim 19, wherein the absorbent core is adhered to the molded polymeric grid layer by overmolding.

30. The surface protection mat of claim 19, wherein the absorbent core further comprises a deformable support layer between the moisture absorbent layer and the moisture barrier layer.

31. A method of preventing the accumulation of liquid on a restroom floor comprising placing the mat of claim 19 on the restroom floor proximate one selected from a commode and a urinal.

32. The method of claim 31, wherein the step of placing the mat on the restroom floor comprises placing the mat on the restroom floor such that the perimeter of the elastomeric grid layer contacts the floor and the moisture barrier layer contacts the floor when no external force is applied to the mat.

33. A method of preventing the accumulation of liquid on the floor of a vehicle, comprising placing the mat of claim 19 on the floor of the vehicle.

34. The method of claim 33, wherein the step of placing the mat on the vehicle floor comprises placing the mat on the vehicle floor such that the surface engaging perimeter of the elastomeric grid layer contacts the floor and the moisture barrier layer contacts the floor when no external force is applied to the mat.
